(19) United States
(12) Patent Application Publication
(10) Pub. No.: US 2003/0128241 A1
(43) Pub. Date: Jul. 10, 2003

(54) Information terminal device

(75) Inventors: Muneaki Watanabe, Hitachi (JP); Akio Shiga, Hitachi (JP)

Correspondence Address: McDermott, Will & Emery, 600 13th Street, N.W., Washington, DC, 20005-3096, US

(73) Assignee: HITACHI, LTD.

(21) Appl. No.: 10/283,301

(22) Filed: Oct. 30, 2002

(30) Foreign Application Priority Data
Jan. 4, 2002 (JP) 2002-000031

(51) Int. Cl. G09G 5/00

(52) U.S. Cl. 345/810

(57) ABSTRACT

The invention provides a menu function able to select an application desirous to be intuitively started in conformity with the rotation of a jog dial.

Therefore, an information terminal device has a jog dial of a rotary type and a menu function for arranging an icon associated with each application stored into the information terminal of a schedule table, an address book, an Internet browser, a mailer, etc. on the screen, and starting the corresponding application by selecting the icon by an operator. The information terminal device has a category managing section for managing a category valid at present by a category managing table, and an icon position managing section for displaying the icon corresponding to each function within the menu screen, and managing an arrangement managing table holding information for starting the application, etc.

### BACKGROUND OF THE INVENTION

1. Field of the Invention

The present invention relates to a menu function for starting a program stored into a portable information terminal device, and particularly, relates to an information terminal device for improving operability by intuitively associating the operations of a jog dial and an application icon arranged on a menu.

2. Description of the Related Art

In recent years, compact information terminal devices have been used in various scenes since these compact information terminal devices are excellent in portable property. Each of these portable information terminal devices has a display section, and a function for starting a stored program (e.g., a schedule table, etc. which are hereinafter called an application) by the display of this display section is mounted as a menu function. In this menu function, it is general to display an icon corresponding to the stored application in the display section, and start the application by designating the icon of a desirable application. The input means of an operation can be constructed by a mouse, a keyboard, etc. However, when the portable property is considered, a problem exists in that the mouse, the keyboard, etc. are used. Further, there is also a method using a touch panel. However, a problem exists in that an operation using both hands is required since a touch pen is required, and no compact information terminal device can be operated by one hand.

To solve this problem, there is a pocket PC “GFORT” manufactured by NTT-DoCoMo corporation as an information terminal device operable by one hand using a jog dial. In accordance with this information terminal device, icons arranged in a lattice shape in the display section are designated by a rotating operation of the jog dial in the vertical direction. The selected icon is inverted and displayed so as to discriminate this selected icon from the unselected other icons. Here, for example, when the jog dial is rotated in the downward direction, the selected icon is moved to the head (i.e., the upward direction) in the next row when the jog dial reaches the lowermost icon. Therefore, a problem exists in that the rotating direction of the jog dial and the moving direction of the selected icon are not conformed to each other, and no intuitive operation can be performed.

There is JP-A-2000-231371 as a technique for solving the above problem. In accordance with this technique, all the icons are arranged in one ring shape, and are rotated and moved by using the jog dial of a rotary type in the same direction as the rotation of the jog dial. The icon located in a predetermined position is enlarged and displayed as a selected icon, and the desirable icon can be designated.

In the technique of the above JP-A-2000-231371, all the icons are arranged and displayed in one ring shape. Therefore, when there are many icons, the icons cannot be displayed once, but are only partially displayed. When the desirable icon is located in a position separated from the icon displayed at present, a problem exists in that many operations of the jog dial are required until the desirable icon is displayed. For example, when an icon located on the side opposed to the present display position is selected, it is necessary to rotate the jog dial many times. In the worst case, when the jog dial is rotated in the opposite direction, it is necessary to operate the jog dial until all the icons go round.

### SUMMARY OF THE INVENTION

In consideration of such a prior art, an object of the present invention is to provide an information terminal device in which an application is divided into categories, and display every category and the movement between the categories can be performed to improve operability in a menu function able to select the application desirous to be intuitively started in conformity with the rotation of the jog dial.

To solve the above problems, a first invention resides in an information terminal device comprising a jog dial of a rotary type, and a menu function for arranging an icon corresponding to each of plural applications of a schedule table, an Internet browser, etc. stored into the information terminal device on the screen, and able to start the corresponding application by selecting and determining the icon by a predetermined operation; wherein the information terminal device further comprises a function for arranging and displaying the icon in a ring shape; and moving the display position of the icon in the same direction as the rotating direction of the jog dial, and selecting the icon located in a predetermined position; a category managing section for dividing the application into at least one or more categories and managing the divided categories; a function for displaying the icon every category by control from the category managing section; and a category moving icon for the movement between the categories; and the category moving icon is arranged so as to be included within the icon display every category, and the movement to a second category can be made by the category moving icon.

Further, the information terminal device is characterized in that the category moving icon is an icon of each of next and back; and the selected icon is the icon of next when the icon of next is selected and determined and the movement to the next category is made and the icon is displayed; and the selected icon is the icon of back when the back is designated and the movement to the previous category is made and the icon is displayed.

A second invention resides in an information terminal device comprising a jog dial of a rotary type, and a menu function for arranging an icon corresponding to each of plural applications of a schedule table, an Internet browser, etc. stored into the information terminal device on the screen, and able to start the corresponding application by selecting and determining the icon by a predetermined operation;

wherein the information terminal device further comprises a function for arranging and displaying the icon in a ring shape, and moving inversion display showing a selection of the icon in the same direction as the rotating direction of the jog dial; a category managing section for dividing the application into at least one or more categories and managing the divided categories; a function for displaying the icon every category by control from the category managing section; and a category moving icon for the movement between the categories; and the category moving icon is arranged so as to be included within the icon display every category, and the movement to a second category can be made by the category moving icon.

Further, the information terminal device is characterized in that the category moving icon is an icon of each of next and back; and the selected icon is the icon of next when the icon of next is selected and determined and the movement to the next category is made and the icon is displayed; and the selected icon is the icon of back when the back is designated and the movement to the previous category is made and the icon is displayed.

In the present invention, it is possible to realize an information terminal device in which an application is divided into categories, and display every category and the movement between the categories can be performed to improve operability in a menu function able to select the application desirous to be intuitively started in conformity with the rotation of the jog dial.

### BRIEF DESCRIPTION OF THE DRAWINGS

FIG. 1 shows one constructional example for realizing the present invention.

FIG. 2 shows an arrangement managing table in the present invention.

FIG. 3 shows a category managing table of the present invention.

FIG. 4 shows a menu function icon arranging example of the present invention.

FIG. 5 is a category transition view of the present invention.

FIG. 6 is a flow chart for realizing the present invention.

FIG. 7 shows one constructional example for realizing a second embodiment of the present invention.

FIG. 8 shows an arrangement managing table of the second embodiment of the present invention.

FIG. 9 is a flow chart for realizing the second embodiment of the present invention.

### DESCRIPTION OF THE PREFERRED EMBODIMENTS

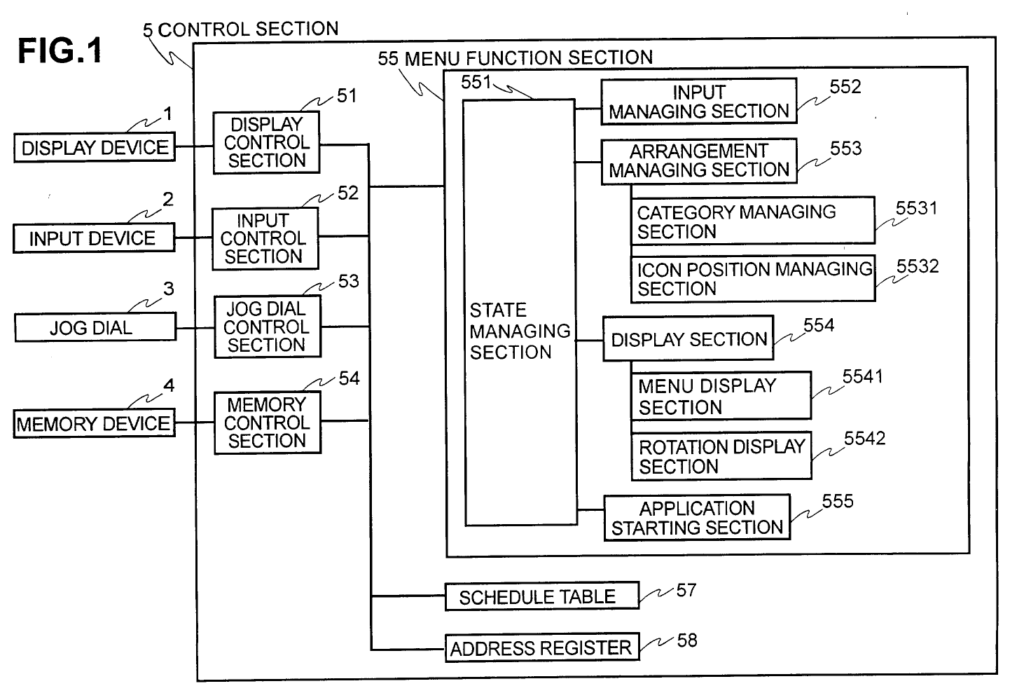

One embodiment mode of a portable information terminal device in the present invention will next be explained by using FIGS. 1 to 9.

FIG. 1 is a constructional view of the portable information terminal device applying a first invention thereto. The construction of this portable information terminal device and the operation of each portion will next be explained.

Reference numeral 1 designates a display device mainly using a liquid crystal, etc., and displaying characters, figures, images, etc. by the instructions of various kinds of applications. Reference numeral 2 designates an input device for receiving an input from a user by mainly using a button, etc. arranged in a device main body. Reference numeral 3 designates a jog dial of a rotary type. The jog dial 3 is one of input devices able to rotate icons or characters, figures, images, etc. displayed on the screen of the above display unit 1 by rotating the jog dial in the clockwise direction or the counterclockwise direction, or able to move these icons, etc. upward, downward, leftward and rightward. Further, a selected application can be determined by pushing the jog dial 3. Reference numeral 4 designates a memory device for storing a data storing area for storing a menu function of the present invention, other various kinds of applications and various kinds of files made by the applications, a program executing area used at an executing time of a program, etc., an arrangement managing table and a category managing table of the present invention described later by mainly using a RAM, a hard disk, a flash memory, etc. Reference numeral 5 designates a control section for controlling the operation of the present information terminal device by various kinds of control sections for controlling the operations of the above-mentioned various kinds of devices of the present information terminal device, various kinds of managing sections, various kinds of application starting sections, etc. The control section 5 will be explained below in detail.

Reference numeral 51 designates a display control section performing a control operation for displaying perceptual information constructed by characters, figures, images, etc. in the display device 1 by the instructions of various kinds of applications, etc. within the information terminal. Reference numeral 52 designates an input control section for notifying input information, etc. inputted from the input device 2 to each control section and each application. Reference numeral 53 designates a jog dial control section. The jog dial control section 53 notifies rightward rotation key information to the various kinds of control sections and the various kinds of applications when the jog dial 3 is rotated in the clockwise direction. The jog dial control section 53 notifies leftward rotation key information to the various kinds of control sections and the various kinds of applications when the jog dial 3 is rotated in the counterclockwise direction. Further, the jog dial control section 53 notifies determining key information to the various kinds of control sections and the various kinds of applications by pushing the jog dial 3. Reference numeral 54 designates a memory control section for controlling the reading and writing operations of data with respect to the memory device 4 by reading and writing requests of user data from the various kinds of control sections and the various kinds of applications. The arrangement managing table and the category managing table used in the menu function of the present invention are also read and written from the memory device 4 through the memory control section 54.

Here, the moving amount of an icon, etc. may be increased and decreased by the speed and the amount of rotation of the jog dial 3.

Further, the determining key information is here inputted from the jog dial 3, but may be also inputted by a separate key.

Reference numerals 55, 57 and 58 designate applications. In FIG. 1, the applications 55, 57 and 58 show a menu function section 55 applying the present invention thereto, a general schedule table function 57 and an address register function 58. Only the general schedule table function 57 and the address register function 58 are described in the information terminal device in addition to the menu function section 55. However, in addition to these functions, there are also many functions such as an Internet browser, a mailer, a document making function, etc.

When the menu function 55 is designated and started, at least one portion within the icons corresponding to the various kinds of applications is displayed as a menu in the display device 1.

The menu function 55 of the present invention will next be explained in detail.

Reference numeral 551 designates a state managing section for controlling the entire operation of the menu function 55 of the present invention by utilizing an input managing section 552, a display section 554 and an application starting section 555 described later. The input managing section 552 sets an input from the input device 2 and the jog dial 3 to an interpretation defined by the menu function section 55 of the present invention, and outputs commands to each section of the menu function section 55 via the state managing section 551. Reference numeral 553 designates an arrangement managing section for performing processing for realizing the present invention, and this arrangement managing section 553 has a category managing section 5531 and an icon position managing section 5532. The category managing section 5531 manages the category number and the category name of an icon of the menu display displayed at present in a starting state of the menu function. The icon position managing section 5532 manages the display position of the icon corresponding to the registered category of an application displayed in the menu, and the registered place of an application program within the memory device 4, etc. The display section 554 has a menu display section 5541 and a rotation display section 5542. The menu display section 5541 performs processing for displaying the menu display screen of a ring shape on the basis of category information and display position information managed by the arrangement managing section 553. The rotation display section 5542 performs processing for rotating and displaying the icon of the menu display. The application starting section 555 starts the application on the basis of the category information and the display position information of the arrangement managing section 553 when a user pushes a determining key of the jog dial 3.

Various kinds of managing data stored to the memory device 4, the arrangement of the icon of the menu display, the construction of a transition example of the display, rotation processing of the icon of the menu display, and category switching processing will next be explained in detail by using FIGS. 1 and 2 to 5.

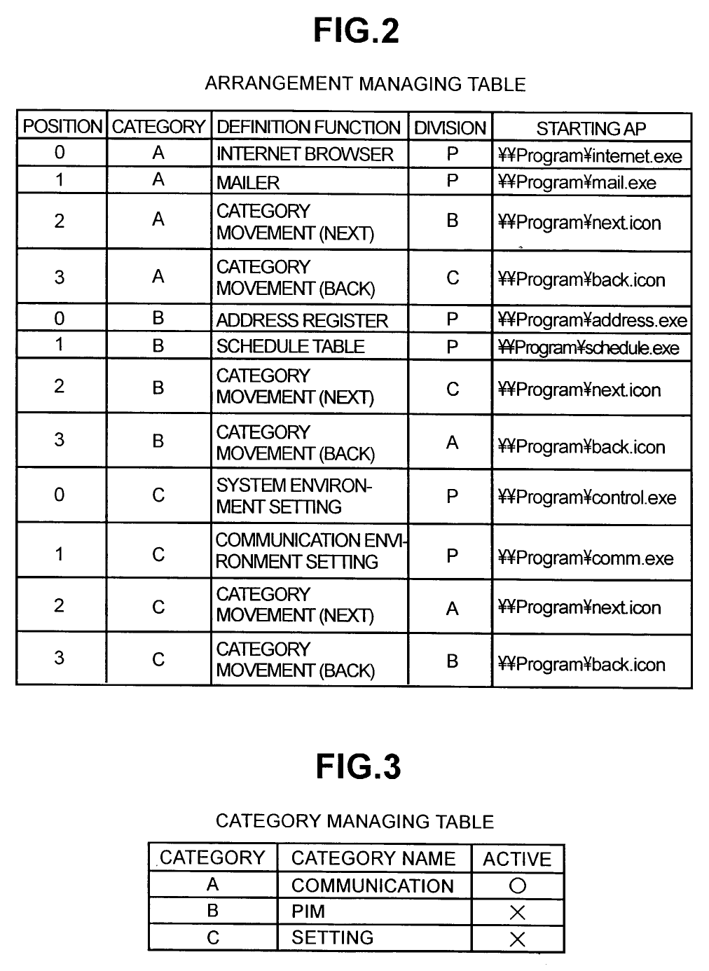

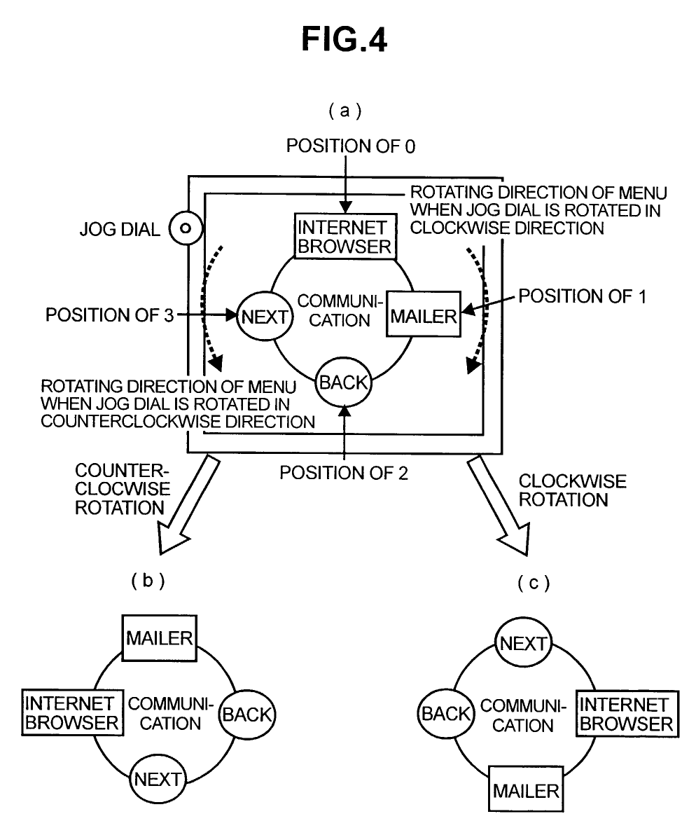

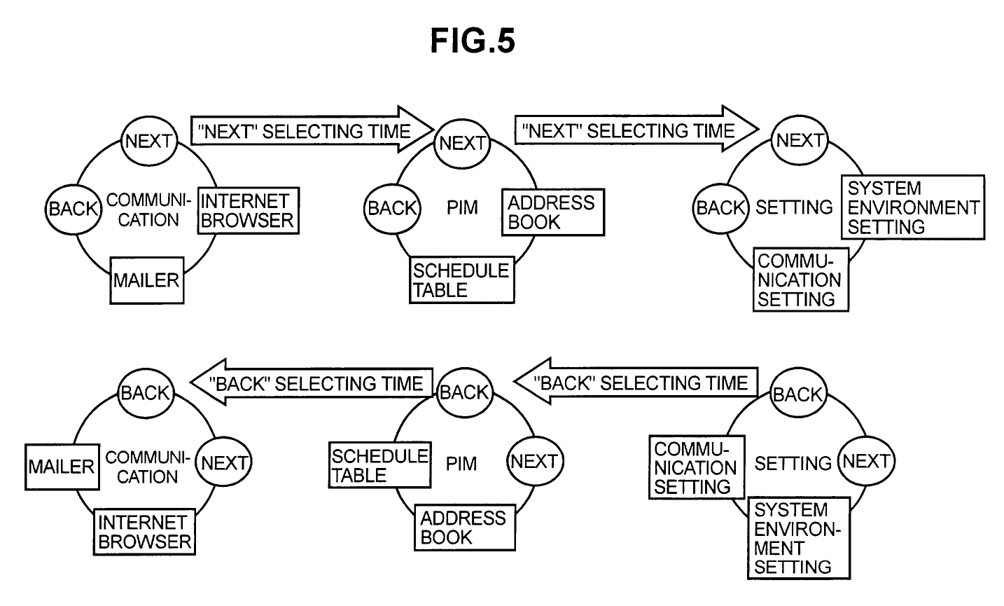

FIG. 2 shows the arrangement managing table. This table shows a data table of the display position of the icon on the screen, the category every application, a definition function of the application, division and a starting application (program) (hereinafter abbreviated as starting AP). This data table is stored to the memory device 4. These data are set in advance and are read under control of the icon position managing section 5532 and update control of the position information is performed. The position shows the display position of the icon displayed on the screen at the time of the menu display, and the category shows the category number to which the defined application belongs. The definition function is the name of a registered application. The division is set to P when the application is registered, and is also set to A, B and C showing the category in the case of category switching. The category number at a switching destination is registered in each case. The starting AP shows a register destination of the starting application when the division is P, and also shows the register destination of a displayed category switching icon in the case of A, B and C. FIG. 3 shows the category managing table. This table shows a data table of the name of each category categorized by the arrangement managing table and the category number (∘ in active column) displayed at present. This data table is stored to the memory device 4. These data are set in advance, and reading control of these data is performed under control of the category managing section 5531. In this example, category A is displayed at present. FIG. 4 shows an arranging example of the icon of the menu display in the menu function. Here, the explanation is made in an embodiment in which four icons are displayed on one screen. FIG. 4A shows the present display example. FIG. 4B shows a display example when the jog dial 3 is rotated in the clockwise direction. FIG. 4C shows a display example when the jog dial 3 is rotated in the counterclockwise direction. Numbers 0 to 3 shown in the column of the position of the arrangement managing table show the display position of the icon. The position of 0 is located in the upper portion of the icon arranged in a ring shape. The position of 1 is located rightward. The position of 2 is located downward. The position of 3 is located leftward. In this embodiment, when the determining key of the jog dial 3 is pushed, the application corresponding to the icon located in the position of 0 is set to be started. FIG. 5 shows a transition view of the category and the icon display when the category switching is selected in the menu display.

When the jog dial 3 is rotated in a state in which the menu function is started and the menu is displayed, the arrangement managing section 553 receives rightward or leftward rotation instructions from the input managing section 552. The category managing section 5531 obtains the category number A displayed at present from the category managing table stored to the memory device 4, and transmits the rotating direction and the category number A to the icon position managing section 5532. In the icon position managing section 5532, when the input information shows the rightward rotation, the position information of the category number A displayed at present within the arrangement managing table is changed from 0 to 1 in the Internet browser, and is changed from 1 to 2 in the mailer, and is changed from 2 to 3 in the category movement (next), and is changed from 3 to 0 in the category movement (back). In contrast to this, when the input information shows the leftward rotation, the position information is changed from 0 to 3 in the Internet browser, and is changed from 1 to 0 in the mailer, and is changed from 2 to 1 in the category movement (next), and is changed from 3 to 2 in the category movement (back). The changed results are notified to the display section 554. When the jog dial 3 is rotated in the clockwise direction on the basis of the changed information as shown in FIG. 4, the icon is rotated in the rightward direction as shown in FIG. 4B and the moved icon is again displayed. In contrast to this, when the jog dial 3 is rotated in the counterclockwise direction, the icon is rotated in the leftward direction as shown in FIG. 4C, and the moved icon is again displayed.

When the determining key of the jog dial 3 is pushed, the arrangement managing section 553 receives determining information from the input managing section 552, and obtains the category number displayed at present in the category managing section 5531, and transmits starting instructions and the category number to the icon position managing section 5532.

The position managing section 5532 notifies starting information to the application starting section 555 when the division corresponding to the position of 0 within the instructed category number is a program. In contrast to this, when the division is the category number, the position managing section 5532 notifies the category number displayed in the category managing section 5531, and instructs redisplay of the menu to the display managing section 554. For example, when the determining key of the jog dial 3 is pushed in FIG. 4A, the category number displayed at present is A, and the application of the Internet browser is located in the position of 0. Accordingly, the Internet browser function is started by the application starting section 555.

The transition of the category is provided as shown in FIG. 5, and there are communication of the category A, PIM of the category B and setting function of the category C. When the category is switched by “next” or “back”, the categories are displayed in the order of category A:communication→B:PIM→C:setting→A:communication→ - - - in the “next” selection. In contrast to this, in the “back” case, the categories are displayed in the order of A:communication→C:setting→B:PIM→A:communication→ - - - .

Here, when the category is switched by “next” or “back”, the arrangement managing table is changed such that the icon displayed in the zeroth position in the category displayed just after the switching is “back” or “next”. Thus, the category switching processing can be rapidly performed when the number of categories becomes plural.

Here, the display of PIM of the category B set to the icon display of an address book corresponds to the application of address register.

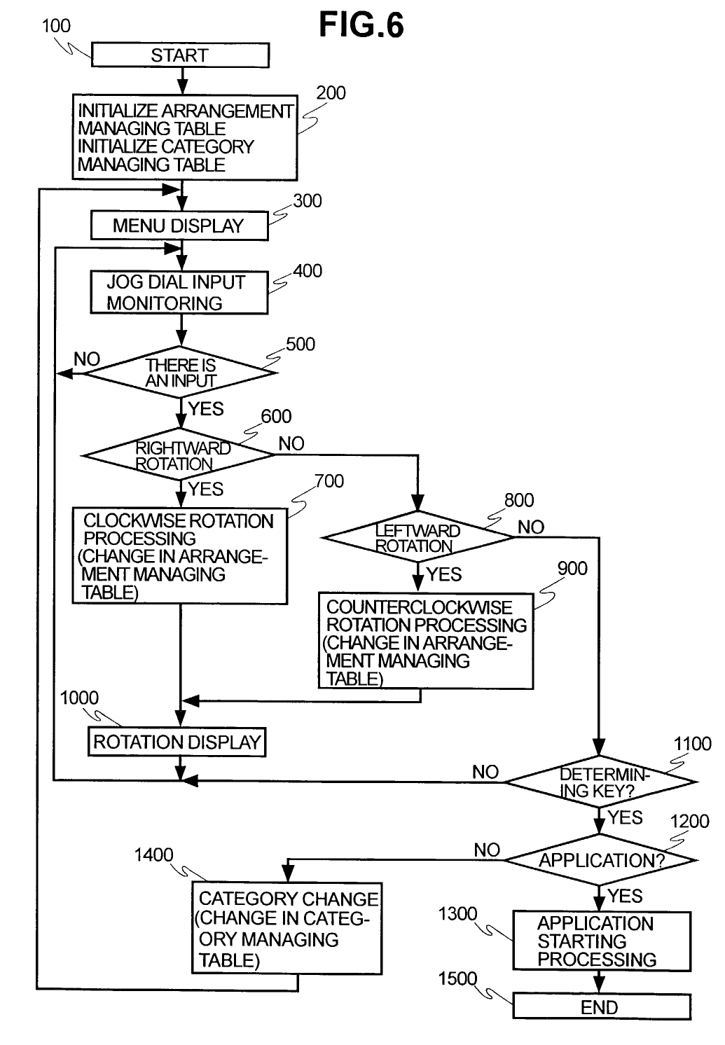

The flow of each processing will next be explained by using the flow chart of FIG. 6.

When the present menu function is started (step 100), the arrangement managing table and the category managing table are first initialized (step 200). In the present invention, these tables are initialized every time as shown in the example described in FIG. 2. However, the arrangement managing table and the category managing table once changed can be stored into the memory device 4 and can be also read from the memory device 4 at an initializing time. Next, the menu screen of a ring shape is displayed on the basis of the category information displayed at present within the arrangement managing table and the category managing table (step 300). Next, it is looped in an input standby state until there is an input from the jog dial 3 (steps 400 to 500). Here, when there is an input from the jog dial 3, it is judged whether the input jog dial 3 is rotated in the rightward direction (step 600). In the case of the rightward rotation, processing describing the arrangement managing table by the rightward rotation processing of the arrangement managing section 553 is executed (step 700). In contrast to this, when no input jog dial 3 is rotated in the rightward direction (step 600), it is judged whether the input jog dial 3 is rotated in the leftward direction (step 800). In the case of the leftward rotation, processing describing the arrangement managing table by the leftward rotation processing of the above arrangement managing section 663 is executed (step 900). After the arrangement managing table is changed by the rightward rotation processing (step 700) and the leftward rotation processing (step 900), processing for really performing the rotation display is performed (step 1000), and it is again returned to the jog dial input monitoring (step 400).

When it is not the rightward rotation in the processing of (step 600) and it is not the leftward rotation in the processing of (step 800), it is judged whether the inputted key is the determining key (step 1100). When the inputted key is the determining key, the category information displayed at present within the category managing table is obtained. Further, it is judged whether the function registered in the position of 0 within the arrangement managing table belonging to this category shows the category switching or the application (step 1200). In the case of the application, the corresponding application within the arrangement managing table is started (step 1300), and the menu of the present invention is terminated (step 1500). In contrast to this, in the case of the category switching in the step 1200, the processing described in the category switching processing of the above arrangement managing section 553 is performed, and it is returned to the menu display (step 300).

When the inputted key is not the determining key in the step 1100, it is judged that an invalid key is inputted, and it is again returned to the jog dial input monitoring (400). Before the end, the position managing table may be stored to the memory device, and may be also read at the initializing time of the position managing table of (step 200). Thus, the position previously terminated can be easily stored.

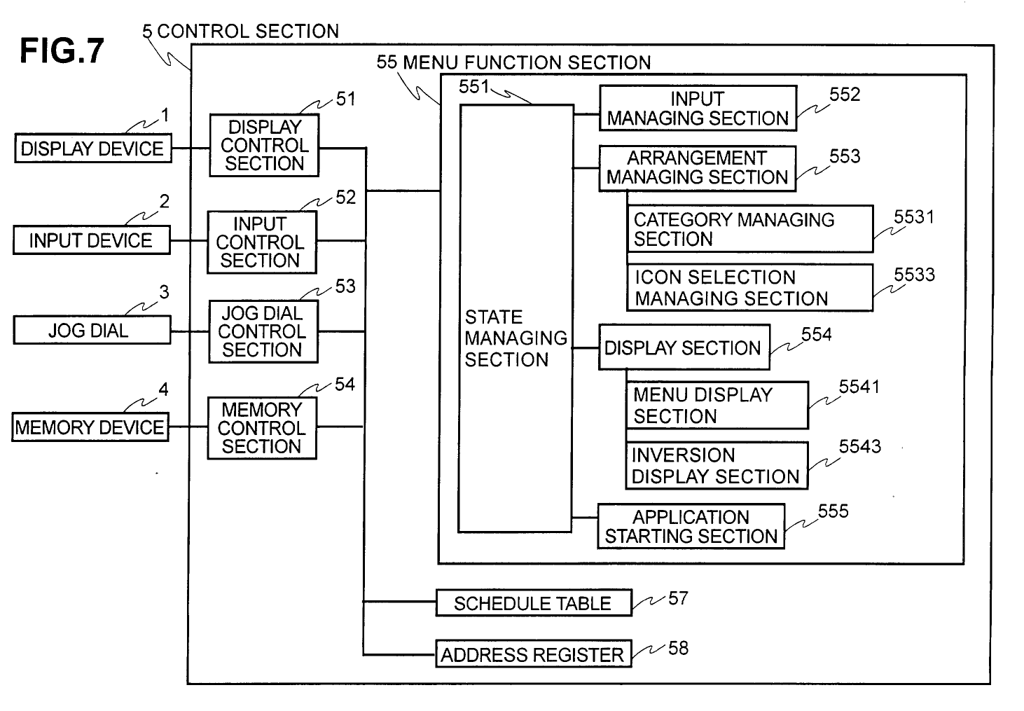

FIG. 7 is a view showing the construction of a portable information terminal device applying a second invention thereto. The second invention differs from the embodiment of the first invention only in that the position managing section 5532 of FIG. 1 is changed to an icon selection managing section 5533 and the rotation display section 5542 is changed to an inversion display section 5543. Accordingly, the explanation will be made with respect to only portions different from those in the first invention.

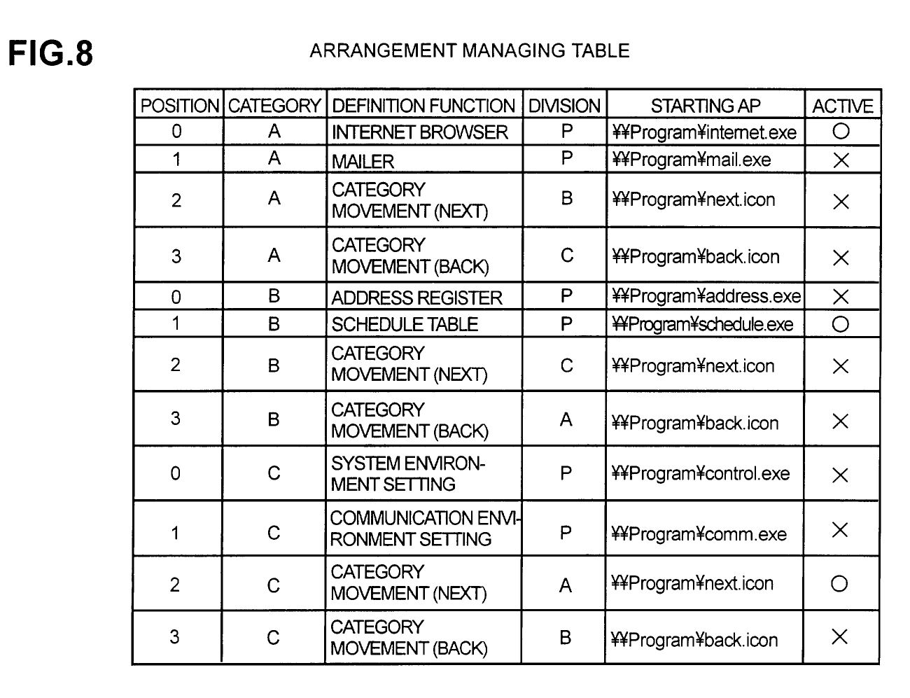

The icon selection managing section 5533 of this second invention manages a change in the position of an icon inverted and displayed on the screen when the jog dial 3 is rotated. Concretely, the explanation will be made by using FIG. 7. In this embodiment, similar to the above claimed embodiment, four icons in one menu screen will be explained in the case of three categories. FIG. 8 shows an arrangement managing table in the embodiment of this second invention. This table shows a data table in which icon information (showing that the icon is inverted during a selection) active at present, etc. are added to the arrangement managing table of the embodiment of the first invention. This data table is stored to the memory device 4. The icon display position is provided as shown in the same FIG. 4A as the embodiment of the first invention. When the jog dial is rotated in the rightward direction, the icon selection managing section 5533 within the arrangement managing section 553 receiving this information of the rightward rotation changes a portion showing the active position of 1 within the arrangement managing table from zeroth to first, from first to second, from second to third, and from third to zeroth. In contrast to this, when the jog dial is rotated in the leftward direction, the icon selection managing section 5533 reversely changes this portion from zeroth to third, from first to zeroth, from second to first, and from third to second. Further, the change information is transmitted to the inversion display section 5543 within the display managing section 554 via a state managing section 551, and the inverted icon is returned to its original icon, and a newly instructed icon is inverted and displayed. An icon peripheral portion or the edge of the icon can be also inverted and displayed by surrounding the circumference of the displayed icon by a frame although this frame is not illustrated.

When a user pushes the determining key of the jog dial 3, the corresponding application information is notified to the application starting section 555 via the state managing section 551 when the icon position set to be active within the active category shows the application in the icon selection managing section 5533. In contrast to this, when the icon position set to be active shows the category switching, similar to the description of the first invention, the category number displayed at present within the category managing table is changed in accordance with the transition of FIG. 5, and the menu of a ring shape of the corresponding category number is displayed in the menu display section 5541 within the display section 554. Since this processing is the same as the description of the first invention, its explanation is omitted here.

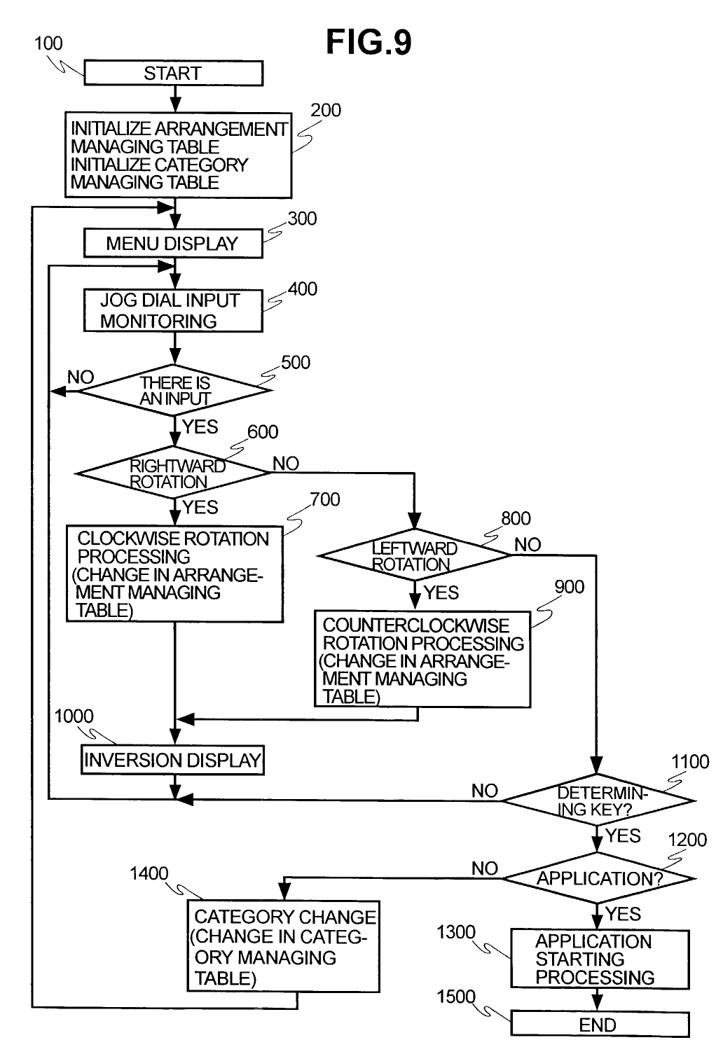

The flow of each processing will next be explained by using the flow chart of FIG. 9. In the flow chart of the second invention, only the processings of (step 300), (step 700), (step 800), (step 1000) and (step 1200) are changed in comparison with the first invention. Accordingly, these change portions will be explained.

In the step 300, initial display is performed and active category information is obtained within the category managing table of FIG. 3. Further, after the icon of the active category obtained within the arrangement managing table of FIG. 8 is displayed, only the active icon is inverted by using the inversion display section. In the step 700, the operation described in the rightward rotation processing of the above icon selection managing section 5533 is performed. In the step 900, the operation described in the leftward rotation processing of the icon selection managing section 5533 is similarly performed. In the step 1000, processing for inverting the icon set to be active is performed, and it is returned to the jog dial input monitoring processing of (step 400). In the application starting processing of (step 1300), processing for starting an application associated with the active icon information in the active category within the arrangement managing table of FIG. 8 is performed.

The second invention can be realized by the above construction.

In this embodiment, the icon of “next” and “back” is used as an icon for the movement between the categories, but no icon for the movement is limited to this icon. For example, the icon showing the category may be also used. Namely, when the icon of category A is displayed, the Internet browser and the icon of a mailer of the category A and category B and category C showing the categories B, C are displayed on the screen. When the category is desirously moved to the category B, the category B is displayed by selecting and determining the icon of the category B. At this time, the icons of an address book, a schedule table, and categories A and C are displayed in the display contents of the category B.

As shown in FIGS. 4 and 5, when the category of “communication”, “PIM” and “setting” is centrally arranged as icons, the category icon arranged at this center can be selected and the category can be easily changed by the jog dial.

Further, information within the arrangement managing table and the category managing table can be changed by an input from the input device 2 so that this information can be selected by a user.

The number of icons, the number of categories and the number of functions displayed on one screen are not limited to the numbers in this embodiment.

Here, the position of the application started at the pushing time of the determining key of the jog dial 3 is set to 0, but is not limited to 0. For example, the position of this application may be also set to a downward position and a corner of the screen. Further, the ring shape is not limited to a circular shape, but may be also set to a polygonal shape.

In accordance with the present invention, the user can select the application intuitively started in conformity with the rotation of the jog dial with good operability, and a desirable application can be simply started only by operating the jog dial.

What is claimed is:

1. An information terminal device comprising a jog dial of a rotary type, a display section and a menu function for arranging an icon corresponding to each application in said display section, and able to start the corresponding application by selecting and determining said icon by a predetermined operation;
wherein the information terminal device further comprises a function for arranging and displaying said icon in a ring shape in said display section, and moving the display position of said icon in the same direction as the rotating direction of said jog dial, and selecting the icon located in a predetermined position; and a category managing section for dividing said application into at least one or more categories and managing the divided categories; the icon is displayed in said display section every category by control from said category managing section; and the information terminal device further comprises a category moving icon for the movement between said categories; and the category moving icon is arranged so as to be included within the icon display every category, and the movement to a second category is made by said category moving icon.

2. An information terminal device comprising a jog dial of a rotary type, a display section and a menu function for arranging an icon corresponding to each application in said display section, and able to start the corresponding application by selecting and determining said icon by a predetermined operation;
wherein said icon is arranged and displayed in a ring shape in said display section and is moved in inversion display showing a selection of said icon in the same direction as the rotating direction of said jog dial; and said information terminal device further comprises a category managing section for dividing said application into at least one or more categories and managing the divided categories; the icon is displayed in said display section every category by control from said category managing section; and the information terminal device further comprises a category moving icon for the movement between said categories; and the category moving icon is arranged so as to be included within the icon display every category, and the movement to a second category is made by said category moving icon.

3. An information terminal device according to claim 1 or 2, wherein said category moving icon is an icon of each of next and back; and the selected icon is the icon of next when the icon of next is selected and determined and the movement to the next category is made and the icon is displayed; and the selected icon is the icon of back when the back is designated and the movement to the previous category is made and the icon is displayed.
